(19) United States
(12) Patent Application Publication
(10) Pub. No.: US 2016/0230594 A1
(43) Pub. Date: Aug. 11, 2016

(54) Steam Turbine and Surface Treatment Method Therefor

(71) Applicant: Mitsubishi Hitachi Power Systems, Ltd., Yokohama (JP)

(72) Inventors: Hiroshi Yamauchi, Tokyo (JP); Takeshi Kudo, Yokohama (JP); Kenji Yashirodai, Yokohama (JP)

(21) Appl. No.: 14/995,668

(22) Filed: Jan. 14, 2016

(30) Foreign Application Priority Data
Feb. 5, 2015 (JP) 2015-020915

(51) Int. Cl. F01D 25/00; B24C 1/10

(52) U.S. Cl. CPC F01D 25/007; B24C 1/10; F05D 2300/142

(57) ABSTRACT

Provided is a steam turbine and a surface treatment method for the steam turbine with which high resistance to environmentally assisted cracking is achieved while also inhibiting the decrease in the effect of compressive residual stress given by shot peening and the complication of the process/treatment. A compressive stress layer to which compressive residual stress has been given by means of shot peening is formed at the surface of a structure (engagement part between a rotor and rotor blades) constituting the steam turbine. Further, a coating layer is formed to cover the surface of the compressive stress layer by means of plating.

### BACKGROUND OF THE INVENTION

1. Field of the Invention

The present invention relates to a steam turbine in a power generation plant or the like and a surface treatment method for the steam turbine.

2. Description of the Related Art

A steam turbine installed in a power generation plant or the like is exposed to corrosive fluid in an oxidizing atmosphere, high-temperature atmosphere, and so forth, and thus metals used for such a structure, except noble metals, undergo deterioration such as corrosion and oxidation. Therefore, such structures are designed in consideration of the corrosion rate and the oxidation rate in an assumed environment so that prescribed strength and functions are maintained for the entire lifetime of the structure. However, since it is impossible to assume all possible events (phenomena) at the stage of designing, there are cases where the corrosion and oxidation progress remarkably owing to an unexpected operation and operating method, change in environment, occurrence of a new phenomenon, or the like.

For example, an engagement part where structures constituting the steam turbine are connected with each other has a gap. Further, stress can concentrate at the engagement part owing to a centrifugal load occurring during the operation. Thus, there is the apprehension that environmentally assisted cracking may occur which is typified by stress corrosion cracking and corrosion fatigue. When the environmentally assisted cracking has occurred, the operation of the power generation plant has to be stopped for inspection and repair and that can hinder stable supply of electric power.

Regarding the environmentally assisted cracking, there have been known three factors: stress, material and environment. The environmentally assisted cracking can be inhibited by reducing the influence of these factors. For example, in regard to the stress, it is possible to use a shape and structure avoiding the stress concentration. In regard to the material, it is possible to reduce the proof stress and use material whose stress corrosion cracking susceptibility is low. In regard to the environment, it is possible to coat or fill up the engagement part or form a sealing part so as to prevent the steam in the steam turbine from entering the engagement part.

Technology related to the reduction of the influence of stress (a factor of the environmentally assisted cracking) on the steam turbine is disclosed in Japanese Unexamined Utility Model Application Publication No. S61-95904, for example. In this technology, a plurality of rotor blades are densely arranged in an outer-circumferential part of a rotor disk to be integral with one another. The rotor disk has a plurality of dovetails arranged circumferentially, while each rotor blade has a dovetail groove facing the dovetail. The rotor disk and the rotor blades are integrated together by engaging the dovetail grooves with the dovetails of the rotor disk. In this configuration, compressive residual stress is given to the dovetails of the rotor disk by means of shot peening.

### SUMMARY OF THE INVENTION

However, the above conventional technology has the following problems.

In cases where compressive residual stress is given to the rotor blade attachment groove parts (groove parts used for attaching the rotor blades) of the rotor by means of shot peening, there can occur a change in dimension, formation of a surface-hardened layer, and/or rough skin, and these can serve as factors of deterioration in the corrosion resistance (i.e., enhance the environmentally assisted cracking due to environmental factors). Thus, these factors have to be removed by conducting mechanical polishing after the shot peening. However, conducting the mechanical polishing after the shot peening not only is troublesome but also has problems in that the compressive stress layer formed with much effort is thinned down and the effect of the compressive residual stress is also weakened.

The object of the present invention, which has been made in consideration of the above-described situation, is to provide a steam turbine and a surface treatment method for the steam turbine with which high resistance to the environmentally assisted cracking is achieved while also inhibiting the decrease in the effect of the compressive residual stress given by the shot peening and the complication of the process/treatment.

To achieve the above object, a steam turbine according to the present invention includes: a compressive stress layer to which compressive residual stress has been given by means of shot peening at the surface of a structure constituting the steam turbine; and a coating layer formed to cover the surface of the compressive stress layer by means of plating.

This configuration makes it possible to provide a steam turbine and a surface treatment method for the steam turbine with which high resistance to the environmentally assisted cracking is achieved while also inhibiting the decrease in the effect of the compressive residual stress given by the shot peening and the complication of the process/treatment.

### BRIEF DESCRIPTION OF THE DRAWINGS

FIG. 1 is a vertical sectional view of a steam turbine according to a first embodiment of the present invention taken along a plane including the rotation axis of the steam turbine.

FIG. 2 is a perspective view excerpting and magnifying part of the structure in part A shown in FIG. 1.

FIG. 3 is a cross-sectional view schematically showing the structure of surfaces of a rotor wheel and a rotor blade facing each other in an engagement part.

FIG. 4 is a schematic diagram for explaining the mechanism of the occurrence of a peeling during the shot peening, showing a state in which a treatment object before the treatment is hit by steel balls.

FIG. 5 is a schematic diagram for explaining the mechanism of the occurrence of the peeling during the shot peening, showing a state in which a dent is hit by a steel ball.

FIG. 6 is a schematic diagram for explaining the mechanism of the occurrence of the peeling during the shot peening, showing a state in which a peeling and a dent have been formed.

FIG. 7 is a graph showing polarization curves of test pieces that had undergone various types of plating treatments.

FIG. 8 is a graph showing the result of a strain resistance characteristic test about cracking, conducted for test pieces that had undergone various types of plating treatments.

FIG. 9 is a graph showing test result of a stress corrosion cracking susceptibility test.

FIG. 10 is a diagram aggregating preparation conditions of test pieces used for the stress corrosion cracking susceptibility test in a tabular format.

FIG. 11 is a diagram aggregating the test result of the stress corrosion cracking susceptibility test shown in FIG. 9 in a tabular format.

FIG. 12 is a cross-sectional view schematically showing the structure of surfaces of a rotor wheel and a rotor blade in a second embodiment facing each other in the engagement part.

FIG. 13 is a perspective view excerpting and magnifying part of the structure in part B shown in FIG. 1.

### DESCRIPTION OF THE PREFERRED EMBODIMENTS

Referring now to the drawings, a description will be given in detail of preferred embodiments in accordance with the present invention.

### First Embodiment

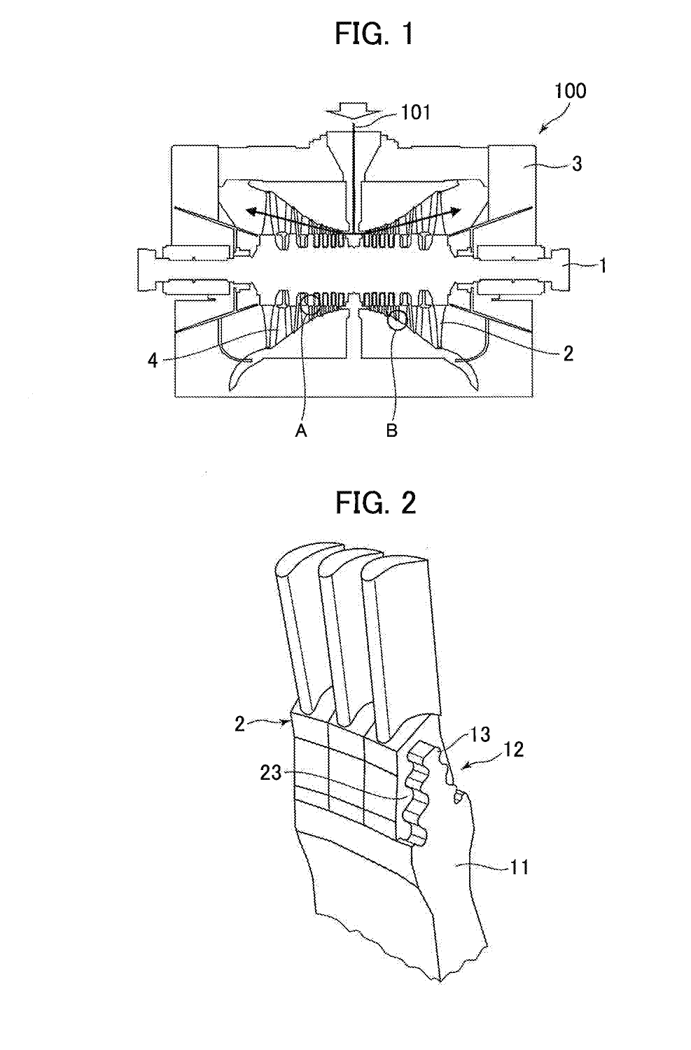

A first embodiment of the present invention will be described below with reference to FIGS. 1 to 11.

FIG. 1 is a vertical sectional view of a steam turbine according to this embodiment taken along a plane including the rotation axis of the steam turbine. FIG. 2 is a perspective view excerpting and magnifying part of the structure in part A shown in FIG. 1.

In FIGS. 1 and 2, the steam turbine 100 is mainly composed of a rotor 1 as a rotating body, a plurality of rotor blades 2 attached around the axis of the rotor 1, stator blades 4 for smoothing the steam 101 supplied to the steam turbine 100 and efficiently supplying the steam 101 to the rotor blades 2, and a casing 3 arranged to surround the rotor 1, the rotor blades 2 and the stator blades 4.

On the rotor 1, multiple stages of disk-shaped rotor wheels 11 are formed in a line in the axial direction. A plurality of rotor blades 2 are arranged on the outer circumference of each rotor wheel 11 to be in close contact with each other in the circumferential direction of the rotor wheel 11.

As shown in FIG. 2, the rotor wheel 11 and each rotor blade 2 are joined with each other in an engagement part 12. While the structure of the engagement part 12 can be designed based on various engagement methods (fitting methods), an example employing tangential entry structure will be explained in this embodiment. In the tangential entry structure, a tree-shaped groove is formed to extend in the circumferential direction of the rotor wheel 11, a corresponding tree-shaped groove is formed also on the rotor blade 2's side, and the tree-shaped grooves on both sides are engaged with each other.

In the engagement part 12, the rotor wheel 11 (i.e., the rotor 1) and the rotor blades 2 are integrated into one body by the engagement between a hook 13 formed by the tree-shaped groove of the rotor wheel 11 and a hook 23 formed by the tree-shaped groove of each rotor blade 2.

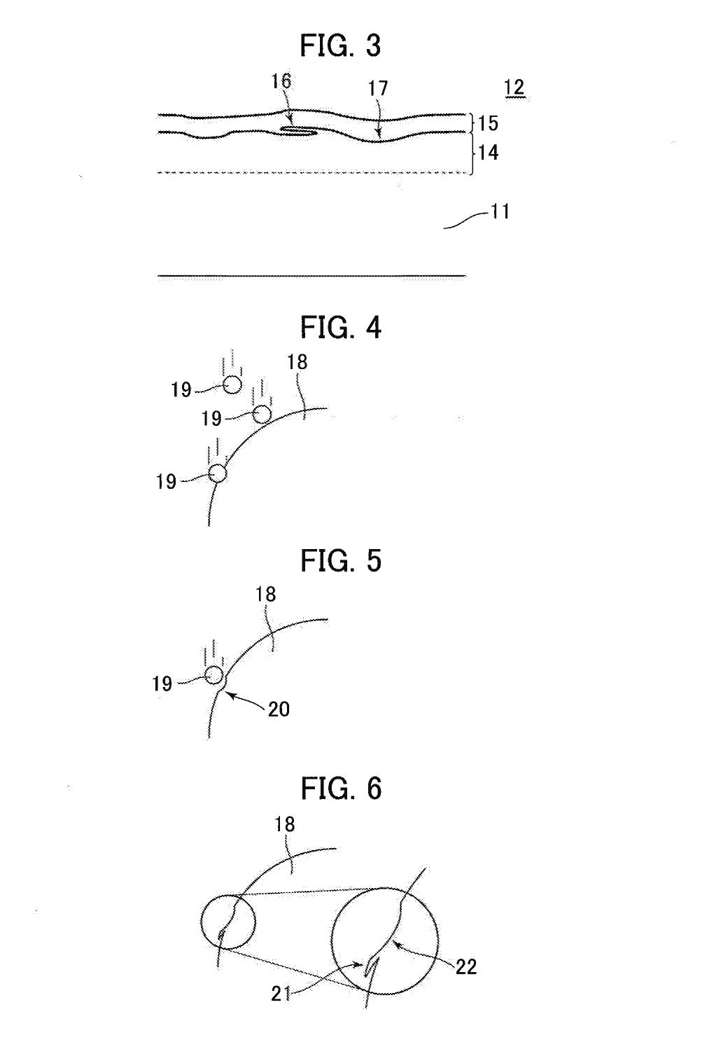

FIG. 3 is a cross-sectional view schematically showing the structure of surfaces of the rotor wheel and the rotor blade facing each other in the engagement part.

In FIG. 3, a surficial region of the engagement part 12 includes a compressive stress layer 14 to which compressive residual stress has been given by means of shot peening and a coating layer 15 having corrosion resistance which has been formed to cover the surface of the compressive stress layer 14 by means of plating.

Here, an example of a concrete method for forming the surficial region of the engagement part 12 will be explained. While this explanation will be given of the rotor 1, the engagement part 12 of the rotor blade 2 is also formed by an equivalent method.

For the rotor 1, a shaft bearing part and the rotor wheels 11 are formed by performing mechanical grinding on an ingot having prescribed chemical composition and mechanical properties. In this process, the tree-shaped groove for the engagement part 12 is formed on each rotor wheel 11 with high precision. Subsequently, the surface is degreased and cleaned (degrease cleaning) and thereafter the compressive stress layer 14 is formed in the surficial region of the engagement part 12 by the shot peening treatment. Since the engagement part 12 has the tree-shaped groove (i.e., the engagement part 12 is in a tree shape), a spray nozzle having a hook-shaped tip end is used so that the shot grains are sprayed (discharged) as orthogonally to the engaging surface as possible. While detailed description of the conditions of the shot peening treatment is omitted here, the quality of material, the dimensions, the discharge pressure, the projection angle, etc. of the shot grains are determined so that the Almen arc height equals a prescribed dimension. After the shot peening treatment, dust and metal particles are removed by using a compressed air jet and the degrease cleaning is conducted again. Then, the coating layer 15 having the corrosion resistance is formed in the surficial region of the engagement part 12 (which has become clean thanks to the degrease cleaning) by means of plating treatment.

Here, the compressive stress layer 14 formed in the surficial region of the engagement part 12 will be explained in detail.

On the compressive stress layer 14, a peeling 16 and/or a dent 17 can be formed in the process of giving the compressive residual stress to the compressive stress layer 14 by the shot peening treatment.

FIGS. 4 to 6 are schematic diagrams for explaining the mechanism of the occurrence of the peeling during the shot peening. FIG. 4 shows a state in which a treatment object (object of treatment) before the treatment is hit by steel balls. FIG. 5 shows a state in which a dent is hit by a steel ball. FIG. 6 shows a state in which a peeling and a dent have been formed.

In the shot peening treatment, shot grains of steel balls 19 are discharged to hit the treatment object 18 (corresponding to the surficial region of the engagement part 12). Therefore, a dent 22 (corresponding to the dent 17) is formed on the surface of the treatment object 18 (see FIG. 4). Further, if a shot grain of a steel ball 19 collides with an inner-radius part (dent mouth) of a dent 22 (see FIG. 5), a peeling 21 (corresponding to the peeling 16) occurs in the vicinity of the dent mouth (see FIG. 6). The frequency of occurrence of the peeling 21 has a tendency to increase with the decrease in the incident angle of the shot grain of the steel ball 19 upon the treatment object (i.e., as the incident angle approaches 0 degrees). The frequency of occurrence of the peeling 21 also has a tendency to increase as the curvature of the treatment object (hit by the shot grain of the steel ball 19) becomes gentler like that in the engagement part 12.

Next, the coating layer 15 formed in the surficial region of the engagement part 12 will be explained in detail. Nickel plating, nickel composite plating, gold plating, gold composite plating or chrome plating is used for the formation of the coating layer 15.

In the engagement part 12 of each rotor wheel 11 of the steam turbine 100, great strain is given to the engagement part 12 by the centrifugal stress of the rotor blades 2. Thus, a coating layer 15 (plating layer) withstanding a certain degree of strain is necessary. Further, the engagement part 12 is exposed to high-temperature steam or high-temperature water at around 80° C. to 130° C., and with the increase in the operating time of the steam turbine 100, corrosive anions such as chloride ions can accumulate in a gap (approximately 0.05 mm to 0.2 mm wide) formed between the rotor wheel 11 and the rotor blade 2 (i.e., formed in the engagement part 12). Therefore, the coating layer 15 (plating layer) itself is required to have the corrosion resistance.

While the diameter of the rotor 1 of the steam turbine 100 is some tens of centimeters in cases of small-sized rotors, the diameter of a large-sized rotor 1 can be as large as several meters. In cases of small-sized rotors 1, intended plating can be applied to appropriate parts by masking parts not needing the plating and dipping the rotor 1 directly into a plating bath. In cases of large-sized rotors 1, the plating layer can be formed on the whole circumference of the rotor 1 by preparing a plating bath of a size enough to immerse the engagement part 12 of a rotor wheel 11, immersing the engagement part 12 in the plating bath, and rotating the rotor 1. Alternatively, it is also possible to prepare a doughnut-shaped plating bath capable of exclusively covering the engagement part 12 and plate each of the rotor wheels 11 one by one. There is no particular limitation on the means for forming the plating layer.

To examine the performance of the plating employed for the coating layer 15 (plating layer) formed as above, three types of tests: a corrosion resistance test, a strain resistance characteristic test about cracking and a stress corrosion cracking susceptibility test, were conducted by using test pieces that had undergone various plating treatments.

For each test, a round-bar test piece in conformity with JIS_Z_2201_14A was used as the test piece. As the material (foundation material) of the test piece for each test, 3.5NiCrMoV steel (3.5Ni-1.75Cr-0.4Mo-0.1V-0.28C steel), widely used for the rotors of currently used low-pressure steam turbines, was used.

Each test piece was formed by refining the material of the test piece by conducting heat treatment/refining (quenching, tempering) so that the 0.2% proof stress of the test piece material equals a prescribed value. The proof stress of the test piece used for each test was set at one of two levels (950 MPa, 850 MPa) higher than the normal level.

The test piece material (proof stress: 850 MPa) after being refined by the heat treatment was processed into a No. 14A round-bar tensile test piece having a parallel-part length of 20 mm (gauge length: 12.5 mm) and a diameter of 3.0 mm. After the processing, the round-bar tensile test piece was degreased with acetone and ethanol and thereafter underwent the shot peening.

After completing the preparation of the round-bar test piece, the shot peening was performed on the test piece from a parallel part to a grip part of the round-bar test piece. The shot peening conditions were set basically in conformity with JIS_B_2711 “Springs—Shot Peening”. By using steel balls 230 μm in diameter for the shot grains, conditions achieving an arc height of 0.23 to 0.25 mm and coverage of 100% were previously determined by using type-A Almen strips. The round-bar tensile test piece was rotated at a constant speed and the shot grains were ejected toward the center line of rotation.

After the shot peening treatment, dust and particles were removed from the surface by use of compressed air and the surface was degreased with acetone and ethanol. Values of the compressive residual stress thus obtained were, as the result of X-ray stress measurement, within a range between −600 MPa and −500 MPa. Further, the thickness of the compressive stress layer 14 (depth of the position of the change from compression to tension) was measured by gradually dissolving the surface by means of electropolishing. The result of the thickness measurement was 0.4 mm on average.

Subsequently, plating treatment was performed on the surface of the round-bar tensile test piece after undergoing the shot peening treatment. The plating material was selected by considering electrolytic nickel plating, nickel-phosphorus plating (including three types: low phosphorus type (phosphorus concentration: approximately 5 mass %), intermediate phosphorus type (phosphorus concentration: approximately 8 mass %), and high phosphorus type (phosphorus concentration: approximately 12 mass %)), electroless plating, hard chrome plating, and gold plating which are industrially mainstream at present. These types of plating were applied to the round-bar test pieces after undergoing the shot peening treatment.

Incidentally, while detailed conditions and methods are not described here about all of the plating types (since the treatment conditions and processes vary widely depending on the plating type), the entire plating process was conducted basically in two stages: pretreatment and plating treatment. The pretreatment includes steps like alkaline degreasing, electrolytic degreasing and activation treatment, for example. The plating treatment includes steps like strike plating, normal plating, hot-water rinsing and drying. Commercially available liquid solutions were used as the various solutions necessary for the pretreatment and the plating treatment. The plating film thickness (plating layer thickness) was set at 0.5 μm to 50 μm.

(1) Corrosion Resistance Test

First, a corrosion resistance test of the plating layer itself was conducted for the prepared test pieces. The corrosion resistance was evaluated by means of the electrochemical polarization curve method. In the measurement, the plated round-bar tensile test piece was provided with lead wires, immersed in a citric acid solution adjusted to pH4 and exposed to the atmosphere, and polarized at a scan rate of 100 mV/min. The amount of electricity was measured during the polarization. Incidentally, the electric potential was kept within a range suitable for preventing dissolution of the plating layer in the solution and exposure of the foundation material of the test piece.

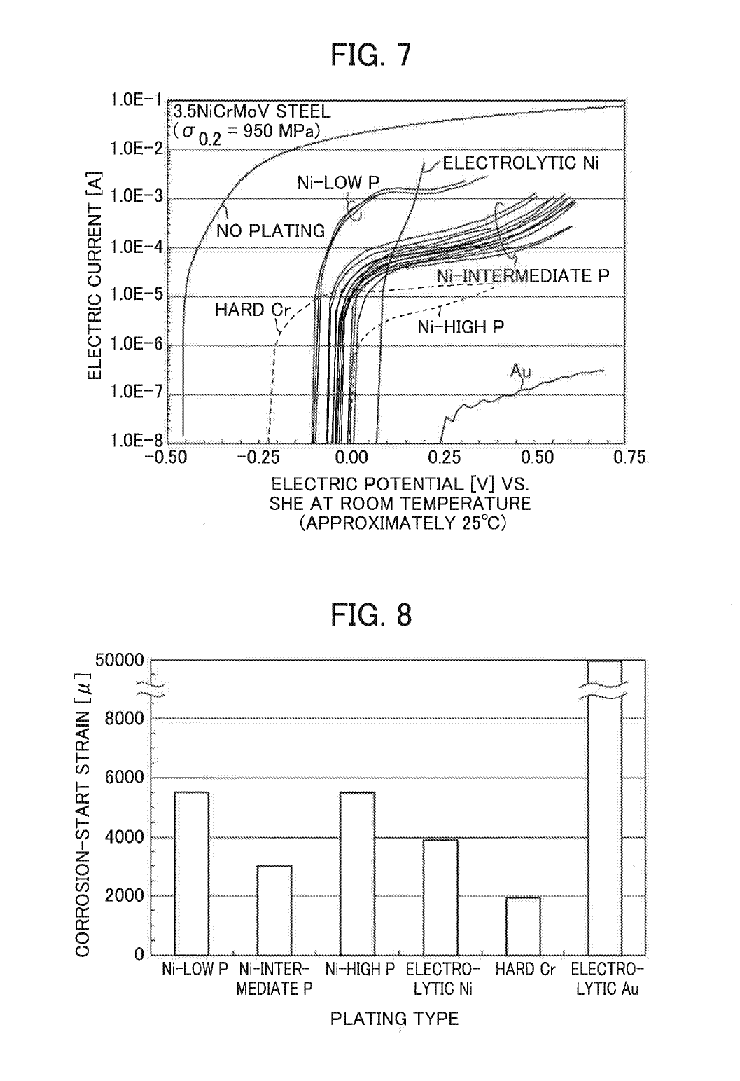

FIG. 7 is a graph showing polarization curves of test pieces that had undergone various types of plating treatments.

In the polarization curve diagram of FIG. 7, the lower electric current on the vertical axis means the higher corrosion resistance. Among the plating types shown in FIG. 7, the type considered to have the highest corrosion resistance is gold plating (Au), followed by nickel-phosphorus plating (high phosphorus type: Ni—High P), hard chrome plating (Hard Cr), nickel-phosphorus plating (intermediate phosphorus type: Ni—Intermediate P), nickel-phosphorus plating (low phosphorus type: Ni—Low P), and electrolytic nickel plating (Electrolytic Ni) in this order. It is clear from this result that gold plating has the highest corrosion resistance and nickel-phosphorus plating (high phosphorus type: Ni—High P) is excellent in terms of cost-effectiveness.

(2) Strain Resistance Characteristic Test about Cracking

Next, by using test pieces similar to those used for the corrosion resistance test, a strain resistance characteristic test about cracking was conducted. Here, the “cracking” means mechanical cracking caused to the test piece by the expansion of the plating layer when strain is given to the test piece.

In the strain resistance characteristic test, a plated round-bar tensile test piece with a strain gauge attached to the test piece's parallel part was immersed in the same solution as that used for the polarization curve measurement and was gradually stretched in the solution. The amount of strain being given to the test piece at the time when the corrosion of the foundation material started was measured. Incidentally, the corrosion of the foundation material was judged based on the increase in the iron concentration in the test solution in which the test piece was immersed.

FIG. 8 is a graph showing the result of the strain resistance characteristic test about cracking, conducted for the test pieces that had undergone various types of plating treatments. In FIG. 8, the horizontal axis represents the plating type and the vertical axis represents the strain at the time when the foundation material was judged to have started corroding.

In the result shown in FIG. 8, the plating type with which the foundation material started corroding at the greatest strain (i.e., the plating type of the highest strain resistance characteristic) was the gold plating (Electrolytic Au), followed by the nickel-phosphorus plating (high phosphorus type: Ni—High P), the nickel-phosphorus plating (low phosphorus type: Ni—Low P), the nickel-phosphorus plating (intermediate phosphorus type: Ni—Intermediate P), the electrolytic nickel plating (Electrolytic Ni), and the hard chrome plating (Hard Cr) in this order.

Incidentally, while the influence of the film thickness of the plating (plating film thickness) was also examined, the corrosion resistance and the strain resistance characteristic did not vary as long as the film thickness was 1 μm or greater. When the plating film thickness was less than 1 μm, the protective function of the plating was poor in every evaluation. Further, a test for checking the thinning speed of the plating layer was also conducted by immersing various plate-shaped test pieces (having various types of plating layers on the foundation material) in high-temperature water (130° C.) at a dissolved oxygen concentration of 16 ppm for 5000 hours. As a result, it was estimated, by assuming the environment around the engagement part 12 of an actual steam turbine, that the plating layer remains existing for approximately 100,000 hours if the original plating film thickness is 20 μm or greater. Therefore, the plating film thickness (plating layer thickness) was set at 20 μm in subsequent tests.

(3) Stress Corrosion Cracking Susceptibility Test

Next, by using test pieces similar to those used for the corrosion resistance test and the strain resistance characteristic test, a stress corrosion cracking susceptibility test (test of susceptibility to the stress corrosion cracking as the representative type of environmentally assisted cracking) was conducted. In the stress corrosion cracking susceptibility test, each test piece was loaded on a stress corrosion cracking tester of the uniaxial constant load type and the time elapsing until the breakage of the test piece was measured.

Comprehensively taking the corrosion resistance, the strain resistance characteristic and the economic efficiency into account, the nickel-phosphorus plating (high phosphorus type: Ni—High P) was considered to be the optimum. Therefore, the nickel-phosphorus plating (high phosphorus type: Ni—High P) was selected as the representative plating type. For comparison of the effect, a plurality of test pieces were prepared under different conditions and used for the stress corrosion cracking susceptibility test.

FIG. 10 is a diagram aggregating the preparation conditions of the test pieces used for the stress corrosion cracking susceptibility test in a tabular format.

In FIG. 10, the test number TP4 represents a test conducted by using a test piece prepared under the conditions according to this embodiment, that is, a test piece prepared by performing the shot peening on a foundation material that had undergone emery paper polishing (as pretreatment) and then conducting the nickel-phosphorus plating (high phosphorus type: Ni—High P) without performing any post-treatment after the shot peening.

The test numbers TP1 to TP3 are used for comparison of effects achieved in the test TP4. The test number TP1 represents a test conducted by using a foundation material that had undergone electropolishing (pretreatment) as the test piece. The test number TP2 represents a test conducted by using a test piece prepared by performing the shot peening on a foundation material that had undergone the emery paper polishing (as pretreatment) and then conducting the electropolishing as post-treatment after the shot peening. The test number TP3 represents a test conducted by using a test piece prepared by performing the nickel-phosphorus plating (high phosphorus type: Ni—High P) on a foundation material that had undergone the emery paper polishing (as pretreatment).

In the stress corrosion cracking susceptibility test, eight or nine test pieces were prepared for each test number and these test pieces were dipped in a circulating autoclave having the uniaxial constant load test function. The load on the test piece is applied by the pressure of the circulated water. The applied stress was set at 1.0 in terms of the 0.2% proof stress (approximately 850 MPa).

Environmental conditions of the test were set so as to realize environmental acceleration for the actual equipment. Specifically, the temperature was set at 130° C., the pressure was set at 80 MPa, the autoclave inlet electric conductivity was set at 0.06 μS/cm, and the autoclave inlet dissolved oxygen concentration was set at 16 ppm. The hydrogen ion concentration (pH) was not controlled.

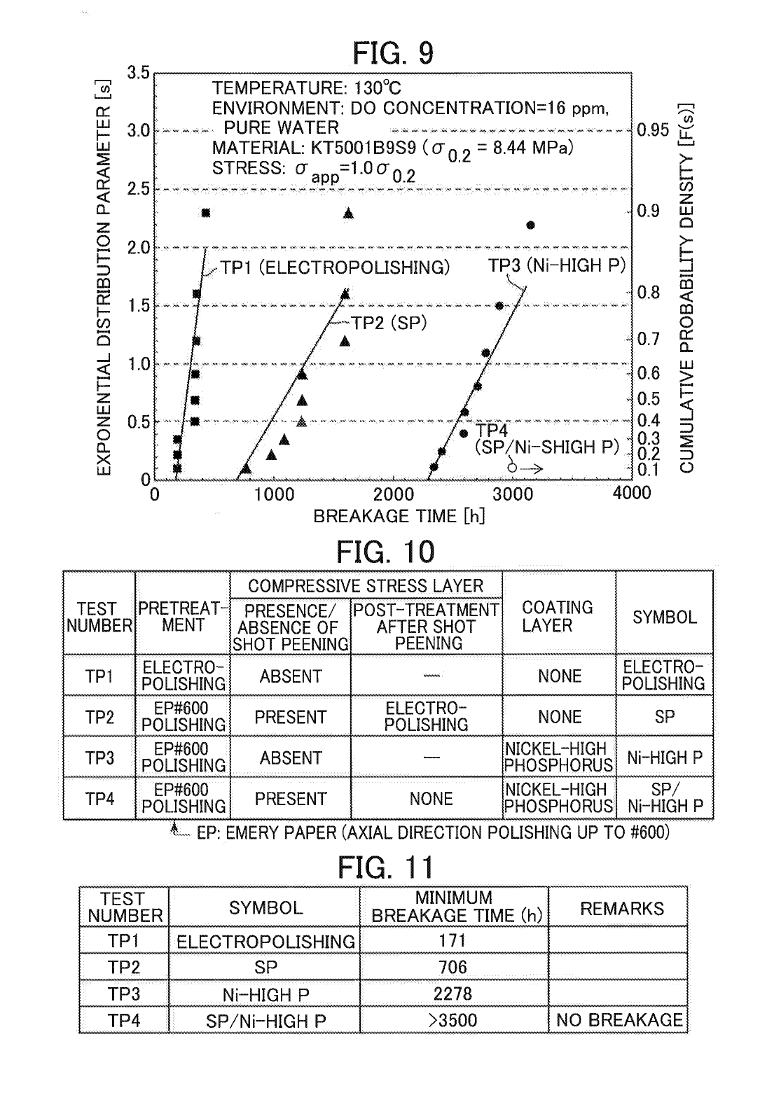

FIG. 9 is a graph showing test result of the stress corrosion cracking susceptibility test, wherein the horizontal axis represents the breakage time and the vertical axis represents the cumulative probability density and the exponential distribution parameter. In FIG. 9, a value obtained by extrapolating the exponential distribution parameter to 0 was defined as a minimum breakage time. The minimum breakage time was handled as an index for evaluating the effect.

FIG. 11 is a diagram aggregating the test result of the stress corrosion cracking susceptibility test shown in FIG. 9 in a tabular format.

As shown in FIGS. 9 and 11, the minimum breakage time in the test TP1 (without the application of the compressive residual stress by means of shot peening (formation of the compressive stress layer) or the plating treatment (formation of the coating layer)) was 171 hours, whereas the test TP2 with only the formation of the compressive stress layer exhibited a considerable effect: a long lifetime (before breakage) approximately four times that in the test TP1. In the test TP3 with only the formation of the coating layer, the effect was still greater, approximately thirteen times that in the test TP1. In the test TP4 assuming a case where the compressive stress layer 14 and the coating layer 15 according to this embodiment are formed, the effect increased still further to a level higher than approximately eighteen times that in the test TP1. Similar effect can be expected also for the corrosion fatigue (cracking that occurs when the stress changes dynamically) since the corrosion fatigue is a phenomenon similar to the stress corrosion cracking.

Operations and effects achieved in this embodiment configured as above will be explained below.

In cases where compressive residual stress is given to the rotor blade attachment groove parts (groove parts used for attaching the rotor blades) of the rotor of a steam turbine by means of shot peening, there can occur a change in dimension, formation of a surface-hardened layer, and/or rough skin, and these can serve as factors of deterioration in the corrosion resistance (i.e., enhance the environmentally assisted cracking due to environmental factors). Thus, these factors have to be removed by conducting mechanical polishing after the shot peening. Especially when the peelings (peeling parts) occur on the surface of the steam turbine due to the shot peening, the peelings serve as gaps or voids and facilitate the occurrence of the stress corrosion cracking. Therefore, removal of the peelings is necessary. However, conducting the mechanical polishing after the shot peening not only is troublesome but also has problems in that the compressive stress layer formed with much effort is thinned down and the effect of the compressive residual stress is also weakened.

In contrast, in this embodiment, the steam turbine 100 is configured to include the compressive stress layer 14 to which compressive residual stress has been given by means of shot peening at the surface of a structure constituting the steam turbine 100 and the coating layer 15 which has been formed to cover the surface of the compressive stress layer 14 by means of plating. Therefore, the stress factor (as a factor of the environmentally assisted cracking) can be removed by the compressive residual stress given to the compressive stress layer 14 by the shot peening. Further, by coating (covering) the rough skin, peelings, etc. caused by the shot peening with the coating layer 15 to prevent the contact with water or steam, the environmental factor (as a factor of the environmentally assisted cracking) can be removed without thinning the compressive stress layer 14. Accordingly, resistance to the environmentally assisted cracking can be enhanced while also inhibiting the decrease in the effect of the compressive residual stress given by the shot peening and the complication of the process/treatment.

Incidentally, while sufficiently low compressive residual stress was successfully given to the compressive stress layer 14 by the shot peeing in this embodiment, the compressive residual stress does not necessarily have to be that low (between −600 MPa and −500 MPa) as long as the local stress applied to the engagement part 12 during the operation of the steam turbine 100 is approximately at the same level as the stress necessary for causing the environmentally assisted cracking (e.g., “stress corrosion cracking lower-limit stress” in the case of stress corrosion cracking). For example, if residual stress at the surface of the engagement part 12 is lower than the bulk residual stress in the rotor wheel 11, the local stress during the operation of the steam turbine 100 is within the stress necessary for causing the environmentally assisted cracking, and thus the effect of the compressive stress layer 14 is achieved sufficiently. The coating layer 15 can also be discussed in a similar manner and the lifetime extension effect can be expected even when some defects exist in the coating layer 15 if the local stress (locally applied stress) is low.

Especially, if the coating layer 15 is formed of material having sacrificial anode-like effect on the materials of the rotor wheels 11 and the rotor blades 2, corrosion of the compressive stress layer 14 is suppressed and the occurrence of the environmentally assisted cracking of the compressive stress layer 14 is inhibited even when the compressive stress layer 14 is partially exposed due to corrosive thinning of the coating layer 15. For example, in the stress corrosion cracking susceptibility test of the test piece represented by the test number TP2 in FIGS. 9 to 11 and explanation thereof in this embodiment, the coating layer 15 (nickel-phosphorus plating) thinned down gradually and the exposure of the compressive stress layer 14 started in part of the parallel part of the test piece when 1500 hours had elapsed. The stress corrosion cracking did not occur even after a while, and the first stress corrosion cracking occurred approximately 700 hours after the exposure of the compressive stress layer 14 was found. In the test piece with the test number TP1 (with no treatment on the foundation material), the stress corrosion cracking started at the time point of approximately 170 hours. Thus, it can be considered that the sacrificial anode effect of the plating layer worked and exhibited itself as the difference in the stress corrosion cracking susceptibility between TP1 (approximately 170 hours) and TP2 (approximately 700 hours). To sum up, even in cases where the coating layer 15 cannot perfectly block the environmental factors, the environmentally assisted cracking can be inhibited and the lifetime can be extended if the coating layer 15 is formed of plating having the sacrificial anode effect.

### Second Embodiment

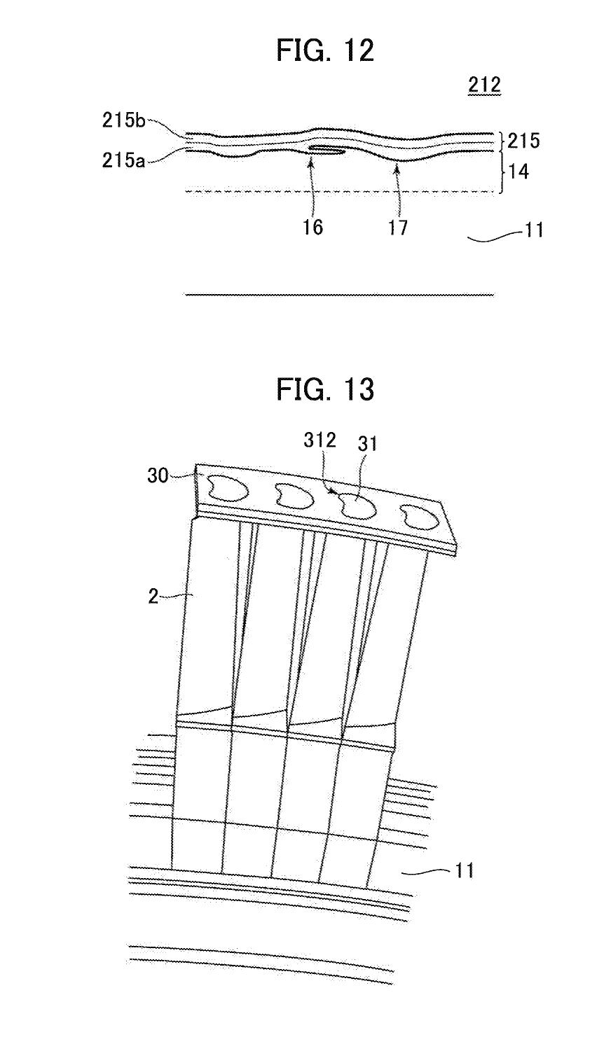

A second embodiment of the present invention will be described below with reference to FIG. 12.

While one plating layer is formed as the coating layer 15 of the engagement part 12 in the first embodiment, two plating layers are formed in this embodiment.

FIG. 12 is a cross-sectional view schematically showing the structure of surfaces of the rotor wheel and the rotor blade in this embodiment facing each other in the engagement part. Elements in FIG. 12 equivalent to those in the first embodiment are assigned the already used reference characters and repeated explanation thereof is omitted for brevity.

In FIG. 12, a surficial region of an engagement part 212 includes a compressive stress layer 14 to which compressive residual stress has been given by means of shot peening and a coating layer 215 having corrosion resistance which has been formed to cover the surface of the compressive stress layer 14 by means of plating.

The coating layer 215 is formed of two layers: a lower layer part 215a formed on the surface of the compressive stress layer 14 by one selected from nickel plating, nickel composite plating and chrome plating and an upper layer part 215b formed on the surface of the lower layer part 215a by one selected from gold plating and gold composite plating.

The rest of the configuration is equivalent to that in the first embodiment.

Also in this embodiment configured as above, effects similar to those of the first embodiment can be achieved.

Further, the effect of the plating layer can be maintained for a longer time without the need of changing the film thickness of the plating layer. Furthermore, from the viewpoint of processing accuracy, the thickness of the plating layer can be reduced without deteriorating the resistance to the environmentally assisted cracking.

Specifically, in cases of nickel-phosphorus plating, for example, the lifetime of the plating layer of 20 μm thick is estimated to be approximately 100,000 hours in the operation environment of the steam turbine. However, there are cases where the effect of the plating layer should be maintained for a longer time or the thickness of the plating layer should be reduced further from the viewpoint of processing accuracy.

On the other hand, according to the result of examining the strain-resistance cracking characteristic (strain resistance characteristic of cracking), penetrative cracking (through crack) occurs in the hard chrome plating layer when strain of approximately 2000μ (μ=10⁻⁶) is given. In the nickel-phosphorus plating, the penetrative cracking occurs at 3000 to 5500μ. In consideration of the local maximum strain (peak value) in the engagement part 12 of the steam turbine 100, there can be cases where strain of 2000 to 3000μ is insufficient.

Thus, in this embodiment, the coating layer is formed of two layers, a general-purpose plating layer (nickel plating, nickel composite plating, hard chrome plating, etc.) is arranged as the lower layer part 215a, and gold plating, gold composite plating or the like excelling in malleability is arranged as the upper layer part 215b.

The gold plating and gold composite plating excels also in the corrosion resistance and the strain-resistance cracking characteristic (strain resistance characteristic of cracking). Therefore, applying gold plating on a plating layer inferior to the gold plating in these characteristics (nickel-phosphorus plating, hard chrome plating, etc.) makes it possible to have the upper layer part 215b successfully protect the lower layer part 215a without cracking (thanks to the excellent anticorrosive effect and malleability of gold) even when great strain is applied. Further, even when a defect exists in the lower layer part 215a or the upper layer part 215b, the probability of a defect extending continuously across the boundary between the lower layer part 215a and the upper layer part 215b decreases. Accordingly, a coating layer 215 having higher protective performance can be formed.

Therefore, the effect of the plating layer can be maintained for a longer time without the need of changing the film thickness of the plating layer. From the viewpoint of processing accuracy, the thickness of the plating layer can be reduced without deteriorating the resistance to the environmentally assisted cracking.

Incidentally, if the plating types of the lower layer part 215a and the upper layer part 215b are interchanged, a plating layer inferior to gold in the corrosion resistance (nickel-phosphorus plating, hard chrome plating, etc.) is arranged as the upper layer part 215b and is made direct contact with the environment. As a result, the gold plating layer of the lower layer part 215a is exposed at an earlier stage. If penetrative cracking (through crack) existed in the gold plating of the lower layer part 215a, steam or water is allowed to reach a rotor wheel 11 or rotor blade 2 through the defect. Therefore, such structure is undesirable. Further, since adhesivity of nickel/chrome plating to gold is not high, the probability of separation of the upper layer part 215b from the lower layer part 215a can increase.

### Third Embodiment

A third embodiment of the present invention will be described below with reference to FIG. 13.

While the present invention is applied to surface structure of the engagement part 12 of the rotor wheel 11 and the rotor blade 2 in the first embodiment, the present invention is applied to surface structure of an engagement part 312 between the rotor blade 2 and a shroud cover 30 in this embodiment.

FIG. 13 is a perspective view excerpting and magnifying part of the structure in part B shown in FIG. 1. Elements in FIG. 13 equivalent to those in the first embodiment are assigned the already used reference characters and repeated explanation thereof is omitted for brevity.

As shown in FIG. 13, a shroud cover 30 for preventing vibration during the operation of the steam turbine is engaged with the tip ends of the rotor blades 2 in the engagement part 312. In the engagement part 312, a tenon 31 formed at the tip end of each rotor blade 2 is fitted in the shroud cover 30. The rotor blade 2 is fixed to the shroud cover 30 by crushing the tenon 31.

A surficial region of the engagement part 312 of the rotor blade 2 and the shroud cover 30 includes a compressive stress layer 14 to which compressive residual stress has been given by means of shot peening and a coating layer (the coating layer 15 or the coating layer 215) having corrosion resistance which has been formed to cover the surface of the compressive stress layer 14 by means of plating. In short, the coating layer 15 in the first embodiment (see FIG. 3) or the coating layer 215 in the second embodiment (see FIG. 12) is employed in the engagement part 312.

The rest of the configuration is equivalent to those in the first and second embodiments.

Also in this embodiment configured as above, effects similar to those of the first and second embodiments can be achieved.

### DESCRIPTION OF REFERENCE CHARACTERS

1: rotor
2: rotor blade
3: casing
4: stator blade
11: rotor wheel
12, 212, 312: engagement part
13, 23: hook
14: compressive stress layer
15, 215: coating layer
16, 21: peeling
17, 22: dent
18: treatment object
19: steel ball
30: shroud cover
31: tenon
100: steam turbine
101: steam

1. A steam turbine comprising:
a compressive stress layer to which compressive residual stress has been given by means of shot peening at the surface of a structure constituting the steam turbine; and
a coating layer formed to cover the surface of the compressive stress layer by means of plating.

2. The steam turbine according to claim 1,
wherein the compressive stress layer is formed at mutually facing surfaces of an engagement part formed in a structure in order to integrally construct the steam turbine with a plurality of structures.

3. The steam turbine according to claim 1,
wherein the coating layer is formed by one selected from nickel plating, nickel composite plating, gold plating, gold composite plating and chrome plating.

4. The steam turbine according to claim 1,
wherein the coating layer is formed of the following two layers:
a lower layer part formed on the surface of the compressive stress layer by one selected from nickel plating, nickel composite plating and chrome plating; and
an upper layer part formed on the surface of the lower layer part by one selected from gold plating and gold composite plating.

5. The steam turbine according to claim 1,
wherein the coating layer is formed of material having sacrificial anode effect on the structure constituting the steam turbine.

6. A surface treatment method for a steam turbine, comprising:
forming a compressive stress layer by giving compressive residual stress by means of shot peening at mutually facing surfaces of an engagement part formed in a structure in order to integrally construct the steam turbine with a plurality of structures; and
forming a coating layer covering the surface of the compressive stress layer by means of plating.
